(19) United States
(12) Patent Application Publication
(10) Pub. No.: US 2023/0229776 A1
(43) Pub. Date: Jul. 20, 2023

(54) METHOD FOR RECEIVING FIRMWARE AND METHOD FOR TRANSMITTING FIRMWARE

(71) Applicant: UNIONPLACE CO., LTD., Seoul (KR)

(72) Inventors: Seongcheol BANG, Seoul (KR); Youngkyu SHIN, Seoul (KR); Seunggyeom KIM, Seoul (KR); Siwan NOH, Seoul (KR); Jonguk JUN, Seoul (KR)

(73) Assignee: UNIONPLACE CO., LTD., Seoul (KR)

(21) Appl. No.: 18/127,420

(22) Filed: Mar. 28, 2023

Related U.S. Application Data
(63) Continuation of application No. PCT/KR2022/010519, filed on Jul. 19, 2022.

(30) Foreign Application Priority Data
Dec. 21, 2021 (KR) 10-2021-0183354

(51) Int. Cl. G06F 21/57; G06F 21/44; G06F 21/60; G06F 8/65

(52) U.S. Cl. CPC G06F 21/572; G06F 21/44; G06F 21/602; G06F 8/65; G06F 2221/033

(57) ABSTRACT

A method includes (a) receiving i-th data among first to n-th data transmitted in a multicast manner from a firmware providing apparatus, (b) acquiring partitioning information thereof, a MAC chaining value, length information, i-th firmware data, and MAC from the i-th data, (c) authenticating the MAC chaining value of the i-th firmware data, the length information, and the i-th firmware data by comparing a MAC of the i-th firmware data with a value computed by a first MAC generation algorithm, which uses the MAC chaining value of the i-th firmware data, the length information, and the i-th firmware data as a relevant input; (d) authenticating the order of the i-th firmware data by using the MAC chaining value of the i-th firmware data and a second MAC generation algorithm; and (e) obtaining the firmware by combining a first to an n-th firmware data obtained by executing (a) to (d).

### CROSS-REFERENCE TO RELATED PATENT APPLICATION

This non-provisional U.S. patent application is a bypass continuation application of PCT International Application No. PCT/KR2022/010519, filed on Jul. 19, 2022, in the WIPO, the international application being based upon and claiming the benefit of priority from Korean Patent Application No. 10-2021-0183354, filed on Dec. 21, 2021, in the Korean Intellectual Property Office, the entire contents of which are hereby incorporated by reference.

### BACKGROUND

### 1. Field

The present disclosure relates to a method for an apparatus in a multicast group to receive firmware and a method for transmitting firmware to a plurality of apparatuses in the multicast group.

The technique disclosed herein was supported by Korea Evaluation Institute of Industrial Technology (KEIT) grant funded by the Korea government {the Ministry of Trade, Industry and Energy (MOTIE)} (Project name: “Development Intelligent Object on AI Applet MCU for High Speed Secure Network,” Project No.: 20017978).

### 2. Related Art

A variety of apparatuses may be connected to a network. In the present specification, apparatuses having communication and computing capabilities are simply referred to as “computing apparatuses” or “apparatuses.”

In order to update firmware of an apparatus, for example, a technology of firmware over-the-air (FOTA) may be used. With FOTA, the apparatus can download and update the firmware thereof over a wireless network.

Meanwhile, a plurality of apparatuses may be grouped as a multicast group. An apparatus that transmits data (hereinafter, also referred to as a “transmitter”) may transmit data to the plurality of apparatuses within the multicast group by using a multicast method. In the multicast method, a multicast address that is set for the multicast group is used.

The plurality of apparatuses in the multicast group sequentially communicate with an apparatus providing firmware by using a unicast method in order to update the firmware. For example, when there are a first apparatus to an n-th apparatus (“n” is a natural number of 2 or greater) in the multicast group, the apparatus providing firmware sequentially provides the firmware to the first apparatus to the n-th apparatus by using the unicast method in such a manner that the apparatus providing firmware provides the firmware to the first apparatus and then provides the firmware to the subsequent apparatus. Even when the plurality of apparatuses in the multicast group have substantially the same configuration (that is, even when the firmware is the same), the plurality of apparatuses sequentially communicate with the apparatus providing the firmware by using the unicast method in order to update the firmware. Therefore, it takes a lot of time for each of the plurality of apparatuses in the multicast group to update its firmware. In addition, a communication load in the multicast network also increases.

In order to make up for the above shortcoming, Korean Patent registration No. 10-1757417 (Patent Document 1), which is filed by JUBIX Co., Ltd., discloses a firmware update method using both a broadcast method and a unicast method.

According to Korean Patent Registration No. 10-1757417, a gateway receives firmware from a parent apparatus (which corresponds to an apparatus providing the firmware in the present specification), divides the firmware into a plurality of images, assigns a sequence number to each of the plurality of images, and transmits the plurality of images to a plurality of apparatuses by using the broadcast method. Further, when one or more apparatuses among the plurality of apparatuses fail to receive one or more images among the plurality of images, the gateway uses a unicast method to transmit the one or more images that have not been received by the one or more apparatuses to the one or more apparatuses based on the sequence number.

However, according to Korean Patent Registration No. 10-1757417, the gateway is used in addition to the apparatus providing firmware, and the gateway can provide firmware only to a plurality of apparatuses within a limited area directly connected to the gateway. Therefore, the application target is limited.

Further, according to Korean Patent Registration No. 10-1757417, the firmware is transmitted to the plurality of apparatuses by using the broadcast method, which leads to a vulnerability in security. More specifically, according to Korean Patent Registration No. 10-1757417, a checksum of the firmware is used to verify that the firmware is normally transmitted. However, even in the case when any one of the plurality of apparatuses operates abnormally due to an attack such as hacking and the abnormally operating apparatus broadcasts tampered firmware, instead of normal firmware, to other apparatuses among the plurality of apparatuses, it is difficult for each of the plurality of apparatuses to determine whether the firmware has been forged or tampered with.

### RELATED ART

### Patent Document

Patent Document 1: Korean Registered Patent No. 10-1757417

### SUMMARY

It is an object of the technique of the present disclosure to provide a method for receiving firmware that facilitates verification of whether the firmware has been tampered with even when the firmware is received in a multicast manner.

It is another object of the technique of the present disclosure to provide a method for transmitting firmware while a firmware tampering is prevented even when the firmware is received in a multicast manner.

In view of the above, according to one aspect of the technique of the present disclosure, there is provided a method for receiving firmware, which is performed by an apparatus in a multicast group, the method including: (a) receiving i-th data among first data to n-th data that are transmitted in a multicast manner from a firmware providing apparatus, wherein “n” is a natural number of 2 or greater and “i” is a natural number from 1 to n; (b) acquiring partitioning information of the firmware, a message authentication code (MAC) chaining value, length information, i-th firmware data, and MAC from the i-th data; (c) authenticating the MAC chaining value of the i-th firmware data, the length information, and the i-th firmware data by comparing a MAC of the i-th firmware data with a value generated and computed by using a first MAC generation algorithm, which uses the MAC chaining value of the i-th firmware data, the length information, and the i-th firmware data as a relevant input; (d) authenticating the sequential order of the i-th firmware data by using the MAC chaining value of the i-th firmware data and a second MAC generation algorithm; and (e) obtaining the firmware by combining a first firmware data to an n-th firmware data obtained by executing (a) to (d).

According to another aspect of the technique of the present disclosure, there is provided a method for transmitting firmware to a plurality of apparatuses in a multicast group, which is performed by a firmware providing apparatus, the method including: (a) generating first firmware data to n-th firmware data on the basis of the firmware, wherein “n” is a natural number of 2 or greater; (b) generates i-th data including partitioning information of the firmware, a MAC chaining value of i-th firmware data, length information, the i-th firmware data, and MAC, wherein “i” is a natural number from 1 to n; and (c) transmitting the i-th data to the plurality of apparatuses in the multicast group in the multicast manner. Further, the MAC of the i-th firmware data is generated and computed by using a first MAC generation algorithm that uses the MAC chaining value of the i-th firmware data, the length information, and the i-th firmware data as a relevant input. Further, the MAC chaining value of the i-th firmware data is generated and computed by using a second MAC generation algorithm that uses a MAC chaining value of (i-1)-th firmware data and the i-th firmware data as a relevant input, if “i” is not equal to 1.

According to the technique of the present disclosure, it is possible to facilitate verification of whether the firmware has been tampered with even when the firmware is received in a multicast manner. In addition, even with an apparatus having low processing performance, it is possible to receive the firmware data in the multicast manner. Further, according to the technique of the present disclosure, it is possible to transmit the firmware while a firmware tampering is prevented even when the firmware is received in a multicast manner.

### BRIEF DESCRIPTION OF THE DRAWINGS

FIG. 1 is an exemplary flowchart of a method for receiving firmware according to a first embodiment of the technique of the present disclosure.

FIG. 2 is a diagram illustrating an exemplary configuration of an apparatus performing the method for receiving firmware according to the first embodiment of the technique of the present disclosure.

FIG. 3 is a diagram illustrating an example of a system environment in which the method for receiving firmware according to the first embodiment of the technique of the present disclosure is employed.

FIG. 4 is a diagram illustrating an example of a structure of i-th data in the method for receiving firmware according to the first embodiment of the technique of the present disclosure.

FIG. 5 is another exemplary flowchart of the method for receiving the firmware according to the first embodiment of the technique of the present disclosure.

FIG. 6 is an exemplary flowchart of a method for transmitting firmware according to a second embodiment of the technique of the present disclosure.

### DETAILED DESCRIPTION

Hereinafter, one or more embodiments (also simply referred to as “embodiments”) of a method of receiving firmware and a method of transmitting the firmware according to the technique of the present disclosure will be described mainly with reference to the drawings. Meanwhile, in the drawings for describing the embodiments of the technique of the present disclosure, for the sake of convenience of description, only a part of the practical configurations may be illustrated or the practical configurations may be illustrated while a part of the practical configurations is omitted or changed. Further, relative dimensions and proportions of parts therein may be exaggerated or reduced in size.

### First Embodiment

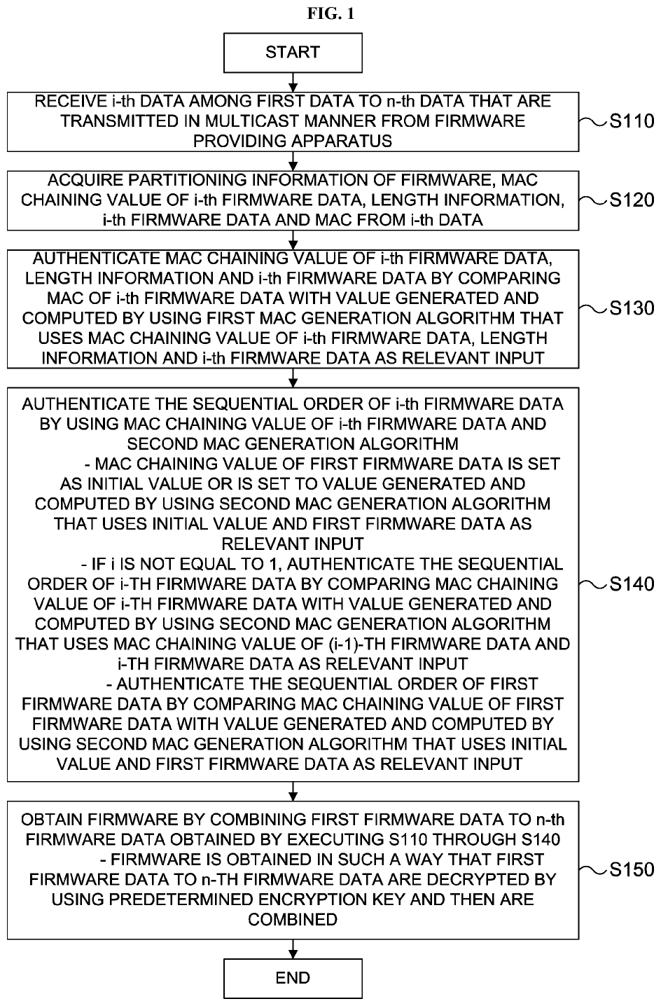

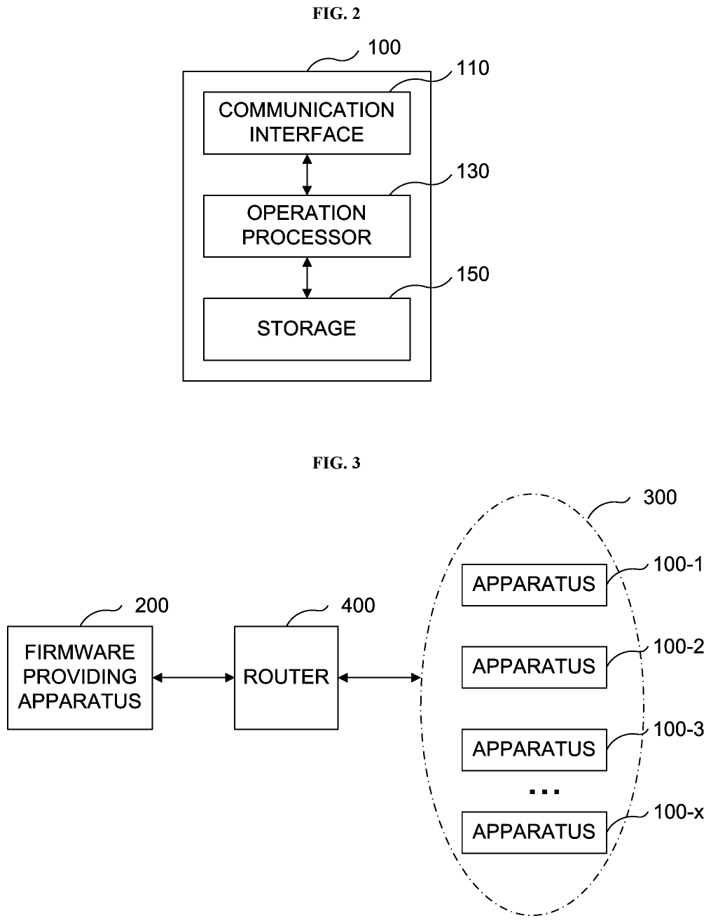

FIG. 1 is an exemplary flowchart of a method for receiving firmware according to a first embodiment of the technique of the present disclosure, and FIG. 2 is a diagram illustrating an exemplary configuration of an apparatus performing the method for receiving firmware according to the first embodiment of the technique of the present disclosure. FIG. 3 is a diagram illustrating an example of a system environment in which the method for receiving firmware according to the first embodiment of the technique of the present disclosure is employed.

Referring first to FIG. 2, there will be described an apparatus 100 performing the method for receiving firmware according to the first embodiment of the technique of the present disclosure.

Referring to FIG. 2, the apparatus 100 performing the method for receiving firmware may include a communication interface 110, an operation processor 130, and a storage 150.

The apparatus 100 may be implemented, for example, using a computing device having data acquisition capabilities, computing capabilities, and communication capabilities. For example, the apparatus 100 may include a computing device, such as a sensor, disposed within a multicast group.

The communication interface 110 is a communication interface that supports wired/wireless communications. The communication interface 110 may be implemented by a semiconductor device such as a communication chip. For example, the communication interface 110 may receive data in a unicast manner or a multicast manner.

The operation processor 130 may be implemented by a semiconductor device, such as a central processing unit (CPU), an application specific integrated circuit (ASIC), or the like.

The operation processor 130 may be implemented, for example, using a plurality of semiconductor devices.

For example, the operation processor 130 may be implemented using a first semiconductor device performing a control function, a second semiconductor device performing encoding/decoding of data, and a third semiconductor device performing encryption/decryption of data.

The operation processor 130 is configured to perform the method for receiving firmware according to the first embodiment, which will be described later, and may control the communication interface 110 and the storage 150 to execute the method for receiving firmware according to the first embodiment.

The storage 150 stores data. The storage 150 may be implemented by a semiconductor device, such as a semiconductor memory.

Next, referring to FIG. 3, there will be described an example of a system environment in which the method for receiving the firmware according to the first embodiment of the technique of the present disclosure is employed.

Referring to FIG. 3, a plurality of apparatuses, i.e., apparatuses 100-1 to 100-x, are located in a network. Here, x is an integer greater than or equal to 2.

Each of the apparatuses 100-1 to 100-x includes a communication interface, an operation processor, and a storage that respectively correspond to the communication interface 110, the operation processor 130, and the storage 150 of the apparatus 100. In the following description, each of the apparatuses 100-1 to 100-x may also be referred to as the apparatus 100.

A firmware providing apparatus 200 is an apparatus that transmits firmware to the plurality of apparatuses, i.e., the apparatuses 100-1 to 100-x. The firmware providing apparatus 200 may be also referred to as the apparatus 200. The apparatus 200 may be implemented by a computing device including a communication interface (not shown), an operation processor (not shown), and a storage (not shown). Since a configuration of the apparatus 200 can be understand by referring to the configuration of the apparatus 100, a detailed description of the configuration of the apparatus 200 will be omitted.

A multicast group 300 includes the apparatuses 100-1 to 100-x.

For example, the apparatus 200 may transmit data to each of the apparatuses 100-1 to 100-x in a multicast manner by using a multicast address set for the multicast group 300. Alternatively, the apparatus 200 may transmit data to one of the plurality of apparatuses in a unicast manner by using an address set for the corresponding one of the plurality of apparatuses. For example, the apparatus 200 may transmit data to the apparatus 100-1 in a unicast manner by using an address set for the apparatus 100-1.

A router 400 is provided between the apparatus 200 and the multicast group 300 to transmit data to the apparatuses 100-1 to 100-x.

Hereinafter, the method of receiving the firmware according to the first embodiment of the technique of the present disclosure will be described in detail.

Referring to FIG. 1, in step S110, the apparatus 100 receives i-th data among first data to n-th data that are transmitted in the multicast manner from the apparatus 200. Here, “n” is a natural number of 2 or greater, and “i” is a natural number from 1 to n. The firmware is partitioned into multiple pieces of firmware data (i.e., first firmware data to n-th firmware data) in the apparatus 200. Then, the first firmware data to the n-th firmware data are respectively converted into first data to n-th data and transmitted to the apparatus 100 in the multicast manner.

For example, the apparatus 200 transmits the first data to the n-th data using user datagram protocol (UDP). The apparatus 100 receives the i-th data among the first data to the n-th data that are transmitted by the use of UDP.

A detailed description of a process in which the apparatus 100 receives the i-th data using UDP will be omitted.

Next, in step S120, the apparatus 100 acquires partitioning information of the firmware, a message authentication code (MAC) chaining value of i-th firmware data, length information, the i-th firmware data, and MAC from the i-th data received in step S110.

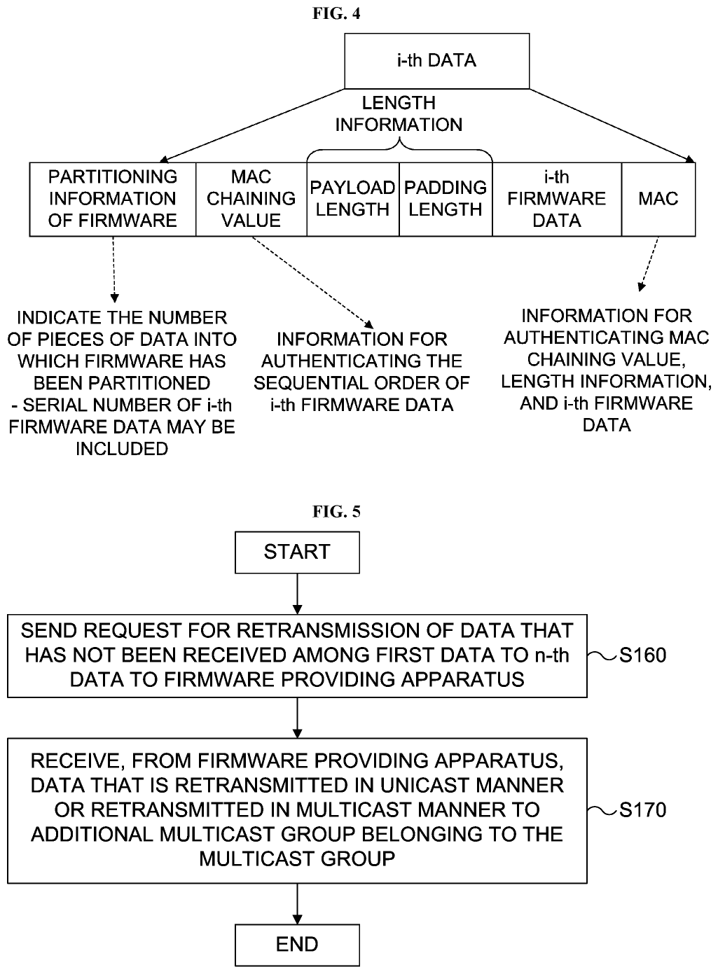

FIG. 4 is a diagram illustrating an example of a structure of the i-th data in the method for receiving firmware according to the first embodiment of the technique of the present disclosure.

As shown in FIG. 4, the i-th data includes the partitioning information of the firmware, the MAC chaining value of the i-th firmware data, the length information (specifically, a payload length and a padding length), the i-th firmware data, and the MAC.

In step S120, the i-th data is interpreted to obtain the partitioning information of the firmware, the MAC chaining value of the i-th firmware data, the length information (e.g., the payload length and the padding length), and the i-th firmware data, and the MAC.

The partitioning information of the firmware may be information that include the number of segments into which the firmware has been partitioned. For example, if the firmware is partitioned into n pieces of data, ranging from the first firmware data to the n-th firmware data, the partitioning information of the firmware may be denoted as “n.”

The partitioning information of the firmware may further include a serial number of the i-th firmware data. For example, if the firmware is partitioned into n pieces of data, ranging from the first firmware data to the n-th firmware data, and the serial number of the i-th firmware data is “i,” the partitioning information of the firmware may include “i” and “n.” For example, when the partitioning information of the firmware is denoted as “0103,” “01” at the first part indicates that the serial number of the i-th firmware data is “1,” and “03” at the second part indicates that the firmware is partitioned into n pieces of data, ranging from the first firmware data to the n-th firmware data.

The MAC chaining value of the i-th firmware data serves as information for authenticating the sequential order of the i-th firmware data.

The length information (more specifically, the payload length and the padding length) may include the length of the payload and the length of the padding in the i-th firmware data. The i-th firmware data may contain only the payload, but may also contain the padding.

The MAC of the i-th firmware data serves as information for authenticating the MAC chaining value of the i-th firmware data, the length information of the i-th firmware data, and the i-th firmware data.

The description of the i-th data shown in FIG. 4 is merely an example, and the first embodiment of the technique of the present disclosure is not limited thereto.

Next, in step S130, the apparatus 100 compares the MAC of the i-th firmware data obtained in step S120 with a value generated and computed by using a first MAC generation algorithm, which uses the MAC chaining value of the i-th firmware data, the length information, and the i-th firmware data obtained in step S120 as the relevant input, to thereby authenticate the MAC chaining value of the i-th firmware data, the length information, and the i-th firmware data obtained in step S120. In other words, the apparatus 100 authenticates the MAC chaining value of the i-th firmware data, the length information, and the i-th firmware data obtained in step S120 by comparing the MAC of the i-th firmware data obtained in step S120 with the value generated according to the first MAC generation algorithm (that is, the MAC of the i-th firmware data computed by using the first MAC generation algorithm).

The first MAC generation algorithm may be implemented using a function such as a hash function.

If the MAC of the i-th firmware data obtained in step S120 is the same as the value generated and computed by using the first MAC generation algorithm, which uses the MAC chaining value of the i-th firmware data, the length information, and the i-th firmware data that are obtained in S120 as the relevant input, the apparatus 100 may determine that the MAC chaining value of the i-th firmware data, the length information, and the i-th firmware data obtained in step S120 have not been forged or tampered with.

If the MAC of the i-th firmware data obtained in step S120 is different from the value generated and computed by using the first MAC generation algorithm, which uses the MAC chaining value of the i-th firmware data, the length information, and the i-th firmware data that are obtained in S120 as the relevant input, the apparatus 100 may determine that the MAC chaining value of the i-th firmware data, the length information, and the i-th firmware data obtained in step S120 have been forged or tampered with.

Next, in step S140, the apparatus 100 authenticates the sequential order of the i-th firmware data by using the MAC chaining value of the i-th firmware data obtained in step S120 and a second MAC generation algorithm.

Step S140 is described in more detail below.

The MAC chaining value of the first firmware data may be set as an initial value. In that case, the apparatus 100 may determine that the i-th firmware data is the first firmware data if the MAC chaining value of the i-th firmware data is the initial value. For example, if “i” is not equal to 1, that is, if the MAC chaining value of the i-th firmware data is not the initial value, the apparatus 100 may compares the MAC chaining value of the i-th firmware data with a value generated and computed by using the second MAC generation algorithm, which uses a MAC chaining value of (i-1)-th firmware data and the i-th firmware data as the relevant input to thereby authenticate the sequential order of the i-th firmware data. Here, the value generated and computed by using the second MAC generation algorithm, which uses the MAC chaining value of the (i-1)-th firmware data and the i-th firmware data as the relevant input, is the MAC chaining value of the i-th firmware data generated according to the second MAC generation algorithm.

The second MAC generation algorithm may be implemented using a function such as a hash function.

It is preferred that the first MAC generation algorithm, which is used to authenticate the MAC chaining value of the i-th firmware data, the length information, the i-th firmware data, is the same as the second MAC generation algorithm, which is used to authenticate the sequential order of the i-th firmware data. However, the first MAC generation algorithm may be different from the second MAC generation algorithm.

Since it is known that the MAC chaining value of the first firmware data is the initial value, the sequential order of each of second firmware data to the n-th firmware data can be authenticated based on the MAC chaining value of each of the second firmware data to the n-th firmware data.

For example, when “i” is equal to 2, the apparatus 100 compares the MAC chaining value of the second firmware data obtained in step S120 with a value generated and computed by using the second MAC generation algorithm that uses the MAC chaining value of the first firmware data and the second firmware data as the relevant input.

If the MAC chaining value of the second firmware data obtained in step S120 is the same as the value generated and computed by using the second MAC generation algorithm that uses the MAC chaining value of the first firmware data and the second firmware data as the relevant input, the sequential order of the firmware data can be determined that the second firmware data is subsequent to the first firmware data.

If the MAC chaining value of the second firmware data obtained in step S120 is different from the value generated and computed by using the second MAC generation algorithm that uses the MAC chaining value of the first firmware data and the second firmware data as the relevant input, the sequential order of the firmware data can be determined that the second firmware data is not subsequent to the first firmware data.

Meanwhile, in the case that the partitioning information of the firmware includes the serial number of the i-th firmware data as described above and the sequential order of the firmware data is thereby determined that the second firmware data is the subsequent firmware data of the first firmware data, if the MAC chaining value of the second firmware data obtained in step S120 is the same as the value generated and computed by using the second MAC generation algorithm that uses the MAC chaining value of the first firmware data and the second firmware data as the relevant input, the apparatus 100 authenticates the sequential order of the firmware data that the second firmware data is the subsequent firmware data of the first firmware data. However, if the MAC chaining value of the second firmware data obtained in step S120 is different from the value generated and computed by using the second MAC generation algorithm that uses the MAC chaining value of the first firmware data and the second firmware data as the relevant input, the apparatus 100 determines that at least one of the MAC chaining value of the first firmware data or the second firmware has been forged or tampered with.

Meanwhile, the MAC chaining value of the first firmware data may be set to a value generated and computed by using the second MAC generation algorithm that uses the initial value and the first firmware data as the relevant input. If “i” is not equal to 1, the apparatus 100 authenticates the sequential order of the i-th firmware data by comparing the MAC chaining value of the i-th firmware data with the value generated and computed by using the second MAC generation algorithm, which uses the MAC chaining value of the (i-1)-th firmware data and the i-th firmware data as the relevant input, as described above. Further, even when “i” is equal to 1, the apparatus 100 may authenticate the sequential order of the first firmware data by comparing the MAC chaining value of the first firmware data with the value generated and computed by using the second MAC generation algorithm that uses the initial value and the first firmware data as the relevant input. That is, the apparatus 100 may authenticate that the first firmware data is the first data of the multiple pieces of firmware data that are partitioned from the firmware.

As discussed above, through step S130 and step S140, it is possible for the apparatus 100 to authenticate the MAC chaining value of the i-th firmware data, the length information, and the i-th firmware data. Further, it is possible for the apparatus 100 to authenticate the sequential order of the i-th firmware data. Therefore, even if data is forged, for example, a part of the i-th data is forged, and the forged data is transmitted to the apparatus 100, the apparatus 100 can easily determine whether the i-th data (more specifically, the i-th firmware data) has been forged or not.

In particular, the apparatus 100 may easily determine whether the i-th data (more specifically, the i-th firmware data) has been forged or not by using both the MAC and the MAC chaining value.

In the above description, the first embodiment has been described on the basis that step S140 is executed after step S130 is executed. However, the first embodiment of the technique of the present disclosure is not limited thereto. For example, step S140 may be executed first and step S130 may be executed next, or step S130 and step S140 may be executed simultaneously or in parallel.

Next, in step S150, the apparatus 100 obtains the firmware by combining the first firmware data to the n-th firmware data obtained by executing step S110 through step S140.

The first firmware data to the n-th firmware data may be encrypted.

Accordingly, in step S150, the apparatus 100 may decrypt each of the first firmware data to the n-th firmware data by using a predetermined encryption key and encryption algorithm, and then the first firmware data to the n-th firmware data are combined to obtain the firmware.

In the process of executing step S110 to step S140, various data may be stored in the storage 150. For example, if, after the first data is received, the second data to be received next is not received and the third data is received, the third data may be stored in the storage 150. In other words, the storage 150 may serve as a buffer. In addition, each of the first firmware data to the n-th firmware data may be temporarily stored in the storage 150, and then the first firmware data to the n-th firmware data are combined in step S150 to obtain the firmware. Further, the firmware obtained in step S150 may be stored in the storage 150.

FIG. 5 is another exemplary flowchart of the method for receiving the firmware according to the first embodiment of the technique of the present disclosure.

Referring to FIG. 5, in step S160, the apparatus 100 sends a request to the apparatus 200 that transmits the firmware to retransmit the data that has not been received even after executing step S110 to step S140.

For example, if the third data is not received among the first data to the n-th data, the apparatus 100 generates a request for retransmission of the third data and sends the generated request to the apparatus 200 that transmits the firmware.

Next, in step S170, the apparatus 100 receives, from the apparatus 200, the data that is retransmitted in the unicast manner or retransmitted in the multicast manner to an additional multicast group belonging to the multicast group 300.

The apparatus 200 may retransmit the third data to the apparatus 100, for example, in the unicast manner. Alternatively, for example, if the third data needs to be retransmitted to one or more apparatuses (e.g., the apparatuses 100-1, 100-2, and 100-3) among the apparatus 100-1 to the apparatus 100-x, the apparatus 200 may retransmit the third data in the multicast manner to a multicast group (i.e., the additional multicast group) that includes the apparatuses 100-1, 100-2, and 100-3.

Once the apparatus 100 receives the data through step S170, the firmware can be obtained through step S120 to step S150.

As described above, according to the first embodiment, the apparatuses in the multicast group may receive firmware data transmitted in the multicast manner. Further, even in the multicast manner, the apparatus may easily determine whether the firmware data has been forged and further determine the sequential order of the partitioned firmware data by using the MAC and the MAC chaining value. Further, if there is firmware data that has not been received, the apparatus may receive the missing firmware data again in the unicast manner or the multicast manner.

### Second Embodiment

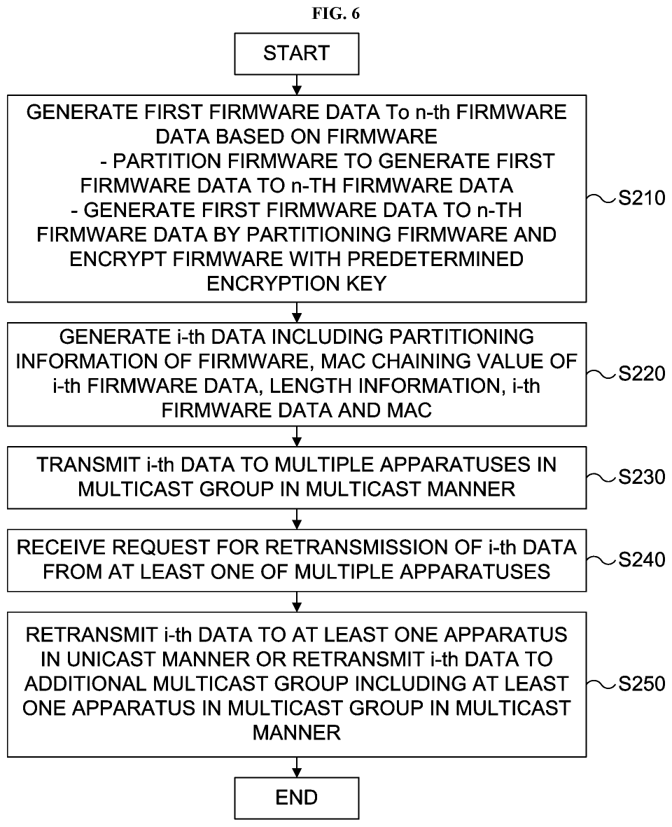

FIG. 6 is an exemplary flowchart of a method for transmitting firmware according to a second embodiment of the technique of the present disclosure.

The detailed description of configurations of the second embodiment that are substantially similar to those described in the first embodiment will be omitted.

Referring to FIG. 6, in step S210, the firmware providing apparatus 200 generates first firmware data to n-th firmware data (where “n” is a natural number of 2 or greater) on the basis of the firmware.

For example, the apparatus 200 may partition the firmware to generate the first firmware data to the n-th firmware data.

Alternatively, for example, the apparatus 200 may generate the first firmware data to the n-th firmware data by partitioning the firmware and encrypt the firmware with a predetermined encryption key.

Next, in step S220, the apparatus 200 generates i-th data including partitioning information of the firmware, a MAC chaining value of i-th firmware data, length information, the i-th firmware data, and MAC. Here, “i” is a natural number from 1 to n.

The MAC of the i-th firmware data may be generated and computed by using the first MAC generation algorithm that uses the MAC chaining value of the i-th firmware data, the length information, and the i-th firmware data as the relevant input.

If “i” is not equal to 1, the MAC chaining value of the i-th firmware data may be generated and computed by using the second MAC generation algorithm that uses a MAC chaining value of (i-1)-th firmware data and the i-th firmware data as the relevant input.

The MAC chaining value of the first firmware data may be generated and computed by using the second MAC generation algorithm that uses an initial value and the first firmware data as the relevant input. Alternatively, the MAC chaining value of the first firmware data may be set as the initial value.

The first MAC generation algorithm may be identical to or different from the second MAC generation algorithm.

The detailed description of the partitioning information of the firmware, the MAC chaining value of the i-th firmware data, the length information, the i-th firmware data, and the MAC will be omitted since those can be understand by referring to the first embodiment described above.

Next, in step S230, the apparatus 200 transmits the i-th data generated in step S220 to a plurality of apparatuses in the multicast group in the multicast manner.

As shown in FIG. 3, the multicast group 300 includes the apparatus 100-1 to the apparatus 100-x.

In step S230, the apparatus 200 transmits the i-th data to, for example, the apparatus 100-1 to the apparatus 100-x in the multicast manner.

In addition, the method for transmitting firmware according to the second embodiment of the technique of the present disclosure may further include step S240 and step S250.

In step S240, the apparatus 200 receives a request for retransmission of the i-th data from at least one of the plurality of apparatuses.

The apparatus 200 transmits the i-th data to the plurality of apparatuses in the multicast group in the multicast manner in step S230. However, since the i-th data is transmitted in the multicast manner, at least one of the plurality of apparatuses in the multicast group 300 may not receive the i-th data. If at least one apparatus among the apparatuses 100-1 to 100-x in the multicast group 300, such as the apparatuses 100-1, 100-2, and 100-3, fails to receive the i-th data, each of the apparatuses 100-1, 100-2, and 100-3 transmits the request for retransmission of the i-th data (i.e., the retransmission request) to the apparatus 200, and the apparatus 200 receives the retransmission request.

Next, in step S250, the apparatus 200 retransmits the i-th data to the at least one apparatus in the unicast manner or retransmits the i-th data to an additional multicast group including the at least one apparatus in the multicast group 300 in the multicast manner.

For example, when the apparatus 200 receives a retransmission request only from the apparatus 100-1 among the apparatuses 100-1 to 100-x in the multicast group 300, the apparatus 200 retransmits the i-th data to the apparatus 100-1 in the unicast manner.

Alternatively, for example, when the apparatus 200 receives a retransmission request from each of the apparatus 100-1, the apparatus 100-2 and the apparatus 100-3 among the apparatuses 100-1 to 100-x in the multicast group 300, the apparatus 200 retransmits the i-th data in the multicast manner to a multicast group (i.e., the additional multicast group) including the apparatuses 100-1, 100-2, and 100-3.

As described above, according to the second embodiment, the firmware providing apparatus may transmit firmware data to an apparatus within the multicast group by using the multicast method. In addition, even when the multicast method is used, the MAC and the MAC chaining value are provided so that each apparatus within the multicast group can easily determine the sequential order of the partitioned firmware data and whether the firmware data has been forged by using the MAC and the MAC chaining value. Further, in response to a retransmission request, the firmware providing apparatus may retransmit at least some of the multiple pieces of the firmware data to one or more apparatuses in the multicast group by using a unicast method or the multicast method.

### Other Embodiments

While the technique of the present disclosure is described in detail by way of the embodiments described above, the technique of the present disclosure is not limited thereto and may be modified in various ways without departing from the scope thereof

For example, the above-described structure of the i-th data is merely an example and may be modified in various ways.

For example, the technique of the present disclosure may also be applied to apparatuses that receive firmware in a multicast group and apparatuses that provide firmware to a plurality of apparatuses in the multicast group.

For example, an apparatus for receiving firmware according to the technique of the present disclosure may include an operation processor that is configured to (a) receive i-th data among first data to n-th data that are transmitted in a multicast manner from a firmware providing apparatus where “n” is a natural number of 2 or greater and “i” is a natural number from 1 to n, (b) acquire partitioning information of the firmware, a message authentication code (MAC) chaining value, length information, i-th firmware data, and MAC from the i-th data, (c) authenticate the MAC chaining value of the i-th firmware data, the length information, and the i-th firmware data by comparing a MAC of the i-th firmware data with a value generated and computed by using a first MAC generation algorithm, which uses the MAC chaining value of the i-th firmware data, the length information, and the i-th firmware data as a relevant input, (d) authenticate the sequential order of the i-th firmware data by using the MAC chaining value of the i-th firmware data and a second MAC generation algorithm, and (e) obtain the firmware by combining a first firmware data to an n-th firmware data obtained by executing (a) to (d).

For example, an apparatus for providing firmware according to the technique of the present disclosure may include an operation processor that is configured to (a) generate first firmware data to n-th firmware data on the basis of the firmware where “n” is a natural number of 2 or greater, (b) generate i-th data including partitioning information of the firmware, a MAC chaining value of i-th firmware data, length information, the i-th firmware data, and MAC where “i” is a natural number from 1 to n, and (c) transmit the i-th data to the plurality of apparatuses in the multicast group in the multicast manner.

Specific technical features described with reference to the first and second embodiments of the technique of the present disclosure may be applied in a similar way to an apparatus for receiving firmware and an apparatus for providing firmware.

Accordingly, the exemplary embodiments disclosed herein are not used to limit the technical idea of the present disclosure, but to explain the present disclosure, and the scope of the technical idea of the present disclosure is not limited by those embodiments. Therefore, the scope of protection of the present disclosure should be construed as defined in the following claims, and all technical ideas that fall within the technical idea of the present disclosure are intended to be embraced by the scope of the claims of the present disclosure.

### Industrial Applicability

According to the technique of the present disclosure, it is possible to facilitate verification of whether firmware has been tampered with even when the firmware is received in a multicast manner. In addition, even with an apparatus having low processing performance, it is possible to receive firmware data in the multicast manner. Further, according to the technique of the present disclosure, it is possible to transmit the firmware while a firmware tampering is prevented even when the firmware is received in a multicast manner.

What is claimed is:

1. A method for receiving firmware, which is performed by an apparatus in a multicast group, the method comprising:
(a) receiving i-th data among first data to n-th data that are transmitted in a multicast manner from a firmware providing apparatus, wherein “n” is a natural number of 2 or greater and “i” is a natural number from 1 to n;
(b) acquiring partitioning information of the firmware, a message authentication code (MAC) chaining value, length information, i-th firmware data, and MAC from the i-th data;
(c) authenticating the MAC chaining value of the i-th firmware data, the length information, and the i-th firmware data by comparing a MAC of the i-th firmware data with a value generated and computed by using a first MAC generation algorithm, which uses the MAC chaining value of the i-th firmware data, the length information, and the i-th firmware data as a relevant input;
(d) authenticating the sequential order of the i-th firmware data by using the MAC chaining value of the i-th firmware data and a second MAC generation algorithm; and
(e) obtaining the firmware by combining a first firmware data to an n-th firmware data obtained by executing (a) to (d).

2. The method of claim 1, wherein the partitioning information includes the

3. The method of claim 1, wherein the partitioning information includes a serial number of the i-th firmware data and the “n.”

4. The method of claim 1, wherein the MAC chaining value of the first firmware data is set as an initial value, and
(d) includes (d-1) authenticating the sequential order of the i-th firmware data by comparing the MAC chaining value of the i-th firmware data with a value generated and computed by using the second MAC generation algorithm, which uses a MAC chaining value of (i-1)-th firmware data and the i-th firmware data as a relevant input, if “i” is not equal to 1.

5. The method of claim 1, wherein the MAC chaining value of the first firmware data is set to a value generated and computed by using the second MAC generation algorithm that uses an initial value and the first firmware data as a relevant input, and
(d) includes (d-1) authenticating the sequential order of the i-th firmware data by comparing the MAC chaining value of the i-th firmware data with a value generated and computed by using the second MAC generation algorithm, which uses a MAC chaining value of (i-1)-th firmware data and the i-th firmware data as a relevant input, if “i” is not equal to 1.

6. The method of claim 5, wherein (d) includes (d-2) authenticating the sequential order of the first firmware data by comparing the MAC chaining value of the first firmware data with a value generated and computed by using the second MAC generation algorithm, which uses the initial value and the first firmware data as a relevant input.

7. The method of claim 1, wherein the first MAC generation algorithm is the same as the second MAC generation algorithm.

8. The method of claim 1, wherein (e) includes (e-1) obtaining the firmware by decrypting each of the first firmware data to the n-th firmware data with a predetermined encryption key and combining the first firmware data to the n-th firmware data.

9. The method of claim 1, further comprising:
(f) sending a request for retransmission of data that is not received among the first data to the n-th data to the firmware providing apparatus, and
(g) receiving, from the firmware providing apparatus, the data that is retransmitted in a unicast manner or retransmitted in a multicast manner to an additional multicast group in the multicast group.

10. A method for transmitting firmware to a plurality of apparatuses in a multicast group, which is performed by a firmware providing apparatus, the method comprising:
(a) generating first firmware data to n-th firmware data on the basis of the firmware, wherein “n” is a natural number of 2 or greater;
(b) generating i-th data including partitioning information of the firmware, a MAC chaining value of i-th firmware data, length information, the i-th firmware data, and MAC, wherein “i” is a natural number from 1 to n; and
(c) transmitting the i-th data to the plurality of apparatuses in the multicast group in the multicast manner,
wherein the MAC of the i-th firmware data is generated and computed by using a first MAC generation algorithm that uses the MAC chaining value of the i-th firmware data, the length information, and the i-th firmware data as a relevant input, and
the MAC chaining value of the i-th firmware data is generated and computed by using a second MAC generation algorithm that uses a MAC chaining value of (i-1)-th firmware data and the i-th firmware data as a relevant input, if “i” is not equal to 1.

11. The method of claim 10, wherein the MAC chaining value of the first firmware data is generated and computed by using the second MAC generation algorithm that uses an initial value and the first firmware data as a relevant input

12. The method of claim 10, wherein the MAC chaining value of the first firmware data is set as an initial value.

13. The method of claim 10, wherein (a) includes (a-1) partitioning the firmware to generate the first firmware data to the n-th firmware data.

14. The method of claim 10, wherein (a) includes (a-2) generating the first firmware data to the n-th firmware data by partitioning the firmware and encrypt the firmware with a predetermined encryption key.

15. The method of claim 10, wherein the partitioning information includes the

16. The method of claim 10, wherein the partitioning information includes a serial number of the i-th firmware data and the “n.”

17. The method of claim 10, wherein the first MAC generation algorithm is the same as the second MAC generation algorithm.

18. The method of claim 10, further comprising:
(d) receiving a request for retransmission of the i-th data from at least one of the plurality of apparatuses, and
(e) retransmitting the i-th data to the at least one of the plurality of apparatuses in a unicast manner or retransmitting the i-th data to an additional multicast group including the at least one of the plurality of apparatuses in the multicast group in a multicast manner.
